(19) United States
(12) Patent Application Publication
(10) Pub. No.: US 2005/0108661 A1
(43) Pub. Date: May 19, 2005

(54) User interface apparatus, and associated method, for facilitating viewing of display indiciaon a user display by a visually-impaired user

(76) Inventor: Douglas Deeds, Bedford, TX (US)

Correspondence Address: Robert H. Kelly;Scheef & Stone, L.L.P., Suite 1400, 5956 Sherry Lane, Dallas, TX, 75225, US

(21) Appl. No.: 10/714,504

(22) Filed: Nov. 13, 2003

(51) Int. Cl. G06F 3/00; G11B 27/00; G06F 17/21

(52) U.S. Cl. 715/865; 715/709; 715/705; 715/707; 715/708; 715/783; 715/855; 715/721; 715/776; 715/542; 715/767; 715/802; 715/821; 715/823

(57) ABSTRACT

User interface apparatus, and an associated method, for facilitating viewing of display indicia by a user of reduced visual acuity. A user display is divided into a first part and a second part. A screen manager operates to cause display at the first part of the user display a sequence of characters in a regular, or small display size. One or more of the characters of the sequence are also caused by the manager to be displayed at the second part of the user display. When displayed at the second part, the character is displayed in enlarged size to facilitate its perception by the user.

The present invention relates generally to a manner by which to facilitate viewing of display indicia displayed upon a user display of a portable communication device, such as a cellular mobile station. More particularly, the present invention relates to user interface apparatus, and an associated method, by which to display selected indicia characters in enlarged form to facilitate their viewing by a visually-impaired user.

The display indicia characters are displayed at a size sufficiently large for the user to be able better to perceive the character while also noting the position of the character in a sequence of display indicia characters in which the enlarged character is positioned. A user display is divided into portions. At a first portion, the sequence of display indicia characters is displayed. And, at a second portion, a single one, or a single set, of the display indicia characters is displayed in enlarged form. The user is better able thereby both to view the display indicia characters and also to recognize its context, i.e., its location in a sequence of characters.

### BACKGROUND OF THE INVENTION

The use of multi-user, radio communication systems has achieved significant levels of usage in recent years. Advancements in communication technologies have permitted the implementation of such radio communication systems to be utilized affordably by large numbers of users through which to communicate.

In a radio communication system, the communication stations that are parties to a communication session, i.e., that form the sending and receiving stations, are connected by way of a radio channel. A radio channel is defined upon a radio link, a portion of the electromagnetic spectrum. Because the communication channel interconnecting the communication stations is defined upon a radio link, the need otherwise to utilize a wireline connection interconnecting the communication stations and upon which to define the communication channel is obviated. Communication is possible, therefore, between locations between which the use of wireline connections would be inconvenient or impractical.

The sending station sends communication data that is to be communicated upon the radio channel to a receiving station. The sending station operates to convert the communication data into a form to permit its communication upon the radio communication channel. Generally, the communication data is modulated upon a carrier that is characterized by a carrier frequency. The carrier frequency of the carrier upon which the communication data is modulated is within a range of frequencies that defines, at least in part, the radio communication channel. Depending upon the communication scheme used by the radio communication system, the channel is further defined, for instance, by timeslots during which the communication data is communicated or code sequences by which the communication data is coded or spread.

A cellular communication system is exemplary of a radio communication system. The network infrastructures of various types of cellular communication systems have been deployed throughout significant portions of the populated areas of the world. Generally, when communications are effectuated in a cellular communication system, communications are effectuated by way of a mobile station that includes radio transceiver circuitry capable of sending and receiving communication data modulated at radio frequencies. Mobile stations are generally constructed to mimic the operation of a conventional, wireline, telephonic device. And, accordingly, a mobile station generally includes an actuation keypad, actuable by a user to initiate a call to a called party. That is to say, the user actuates the actuation keypad to enter the dialing digits associated with a called party. Also, a user display screen is provided. Numeric information is displayable upon the display screen, such as the numeric identifier identifying a calling party of a call that is placed to the mobile station as well as the numeric indicators identifying the numbers of the dialing digits that the user enters when initiating a call from the mobile station.

The user display screen is further used at which to display textual data, such as text messages that are sent to the mobile station, as well as text messages that are generated at the mobile station for communication elsewhere. Also, increasingly, mobile stations are utilized for multi-media, and other, communication services in which iconic symbols and images form the communication data that is communicated pursuant to a communications session to effectuate a communication service.

The radio transceiver circuitry of many mobile stations are of minimal dimensions, permitting the circuitry to be housed in small-sized housings, oftentimes of dimensions permitting their hand-carriage by a user and storage in the user's shirt pocket, or the like. The user interface of the mobile station is correspondingly also of small dimensions as the user interface is positioned at the housing of the mobile station to permit the user to actuate the actuation keys thereof and to view display indicia displayed on the user display.

While the user interface of a mobile station remains generally of dimensions that permit a user of the mobile station easily to interface therewith to actuate the actuation keys and to view display indicia displayed upon the user display, a user that suffers from a physical disability might well have difficulty in interfacing with the user interface.

For instance, a visually-impaired user, depending upon the extent of the impairment, might be unable to view the display indicia displayed upon the display screen. More generally, a user of diminished visual acuity that utilizes other devices that have user displays of screen sizes of small dimensions similarly might be unable readily to perceive the display indicia displayed on such screen displays.

Various existing schemes are used to better the likelihood that a visually-impaired user is able to perceive the display indicia displayed upon the screen of the user display. For instance, some user interfaces provide the ability to increase, or decrease, the size of the display indicia that is displayed, such as, e.g., altering the font size of text characters. This scheme, however, is not ideal as, when sufficiently large increases in the size of the display indicia are provided, only a few characters are displayable on the screen at any time. The location of the enlarged display indicia within a sequence of display indicia is sometimes difficult to determine by the user.

In another scheme, magnification of a portion of the display screen of the user display is provided. However, the magnification location changes as successive characters of a sequence of display indicia are viewed. The user must move his or her visual focus as the successive characters of the display indicia are traversed. Due to the disparity of sizes between the magnified indicia viewed by the user and surrounding indicia, the display screen is required to be reformatted as subsequent ones of the successive display indicia are magnified.

Accordingly, existing techniques by which to display the display indicia in a form facilitating its viewing by a user of impaired visual acuity are inadequate. An improved manner by which to facilitate viewing of the display indicia by a user of impaired visual acuity is, therefore, required.

It is in light of this background information related to user interfaces used in portable communication devices that the significant improvements of the present invention have evolved.

### SUMMARY OF THE INVENTION

The present invention, accordingly, advantageously provides apparatus, and an associated method, by which to facilitate viewing of display indicia displayed upon a user display of a portable communication device, such as a cellular mobile station.

Through operation of an embodiment of the present invention, a manner is provided by which to display selected indicia characters in enlarged form to facilitate their viewing by a visually-impaired user.

The user is better able to perceive the display indicia characters as the characters are displayed at a sufficiently-large size. And, the position of the character is noted in a sequence of display indicia characters in which the enlarged character is positioned.

A user interface includes a user display that is divided into at least two portions, a first portion and at least a second portion. The first portion is utilized by which to display a sequence of display indicia characters, such as a numeric identifier that is entered by a user of the mobile station to initiate a call or the numeric identifier of a calling party that places a call to be terminated at the mobile station. One character of the sequence of characters is also displayed at the second portion of the user display. One or more additional characters are also displayed, if desired, at the second portion of the user display. The character, or characters, displayed at the second portion of the user display are displayed in enlarged form. The display of the character or characters in enlarged form facilitates perception of the displayed character or characters by a user that views the characters. When the user suffers from impaired vision, the enlarged form of the character or characters displayed at the second portion of the user display is more likely to be perceived accurately by the user than when displayed only in non-enlarged form.

The character, or characters, displayed at the second portion of the user display is also concurrently displayed at the first portion as part of the sequence of characters. Such character, or characters, are offset, in a selected manner, from others of the characters of the sequence of characters. For instance, when the user display is a color display, the character of the sequence that is also concurrently displayed in enlarged form at the second screen portion is displayed in a color dissimilar to the color at which the other characters of the sequence are displayed. And, in one implementation, the colors of the character, or characters, concurrently displayed at both the first portion and the second portion of the user display are displayed in the same color, the color selected being a color different than the color at which the remaining ones of the characters of the sequence displayed at the first portion are displayed. While a visually-impaired user might not be able to perceive the identities of the characters displayed at the first portion, the position of the character is better able to be perceived and its identity perceived at the second portion.

A user display screen manager operates to manage the display of the display indicia characters at the first and second portions of the user display. The manager is provided with indications of the display indicia that is to be, and is available to be, displayed at the user display. The manager manages the display indicia characters to display at least a portion of a sequence of the display indicia characters at the first portion of the user display and to select and to display a selected character of the sequence at the second portion, in enlarged form. The manager further selects in what manner to indicate at the first portion which of the characters is also concurrently displayed at the second portion. If an offset in color is unavailable by which to offset such character, the manager selects, for instance, bold-facing, reverse characters, or another manner by which to offset the character so that a user is able better to perceive the position of the character in the sequence that is also shown in enlarged form at the second portion of the user display.

The user display screen manager further successively selects and reselects which characters to display at the second portion of the user display. Selection is made, for instance, responsive to user input at a user actuator so that the change in display indicia characters displayed in the enlarged form at the second portion of the user display is manually effectuated, i.e., responsive to user command. Alternately, the selection, and reselection, is made at selected intervals, such as at periodic intervals.

Thereby, a user, even one visually impaired, is able better to perceive the display indicia characters that are displayable upon a user display of a user interface. The display indicia characters are displayed in enlarged form and their position within a sequence of display indicia characters is also indicated. The context of the character in a sequence of characters is thereby better determinable.

In these and other aspects, therefore, apparatus, and an associated method, is provided for a portable communication device operable in a communication system. Viewing of display indicia by a visually-impaired user is facilitated. A display screen has a first screen portion and at least a second screen portion. The first screen portion selectably displays a first selected portion of the display indicia at a first display indicia size. The second screen portion selectably displays a second selected portion of the display indicia at a second display indicia size. The first and second selected portions, respectively, have an overlapping display indicia element. A user display screen manager is adapted to receive indications of the display indicia to be visually displayed. The user display screen manager selects which part of the display indicia to comprise the second selected portion displayed at the second screen portion. And, the user display screen manager manages display of the first and second selected portions, respectively, at respective ones of the first and second screen portions of the screen display.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

FIG. 1 illustrates a functional block diagram of a radio communication system having a mobile station in which an embodiment of the present invention is operable.

FIG. 2 illustrates an exemplary screen display generated during operation of an embodiment of the present invention.

FIG. 3 illustrates an exemplary screen display, similar to that shown in FIG. 2, but of another display generated during operation of an embodiment of the present invention.

FIG. 4 illustrates an exemplary screen display, corresponding to that shown in FIG. 3, but in which another display indicia character of a sequence of display indicia characters is displayed in enlarged form.

FIG. 5 illustrates an exemplary screen display, analogous to those shown in FIGS. 3-4, but here in which another display indicia character is displayed in enlarged form.

FIG. 6 also illustrates an exemplary screen display formed pursuant to operation of an embodiment of the present invention, similar to those shown in FIGS. 3-5, but here illustrating another display indicia character is displayed in enlarged form.

FIG. 7 illustrates another exemplary screen display, similar to those shown in FIGS. 3-6, but here in which another display indicia character is displayed in enlarged form.

FIG. 8 illustrates a method flow diagram listing the method steps of the method of operation of embodiment of the present invention.

### DETAILED DESCRIPTION

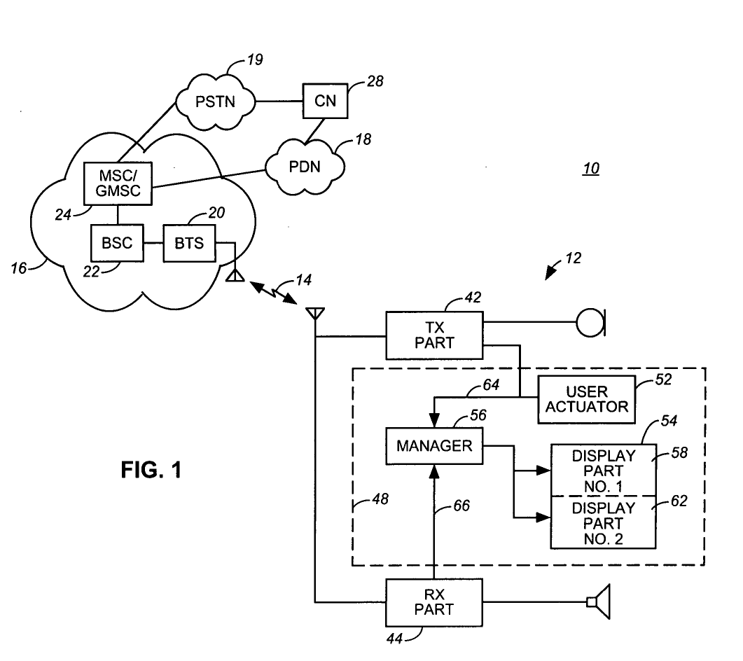

Referring first to FIG. 1, a radio communication system, shown generally at 10, provides for the communication of communication data with a mobile station 12. Communication of the communication data is effectuated with the mobile station by way of radio channels defined upon a radio link 14. In the exemplary implementation, the communication system forms a cellular communication system operable pursuant to an appropriate operating standard. While the following description shall describe operation of an embodiment of the present invention in which the communication system comprises a cellular communication system, such as a cellular communication system operable pursuant to a GSM (Global Sysem for Mobile communications) communication system, it should be understood that operation of an embodiment of the present invention is analogously implementable in other types of communication systems.

The communication system also includes a network part with which the mobile station communicates by way of the radio channels defined upon the radio link. Here, the network part is defined to include a radio access network (RAN) 16, a packet data network (PDN) 18, and a public-switched telephonic network (PSTN) 19.

The radio access network includes a plurality of base transceiver stations (BTSs), of which a single base transceiver station 20 is shown in the figure. Each of the base transceiver stations defines a coverage area, referred to as a cell. When a mobile station, such as the mobile station 12, is positioned within a cell defined by a base transceiver station 18, communications with the mobile station are generally effectuated by way of the base transceiver station that defines the cell within which the mobile station is positioned.

The base transceiver station 20 is coupled to a base station controller (BSC) 22. Typically, one base station controller is coupled to a group of base transceiver stations. The base station controller operates to perform various control functions that control operation of the base transceiver stations that are coupled to the base station controller. Operations controlled by the base station controller include, for instance, channel allocations for communication sessions with mobile stations positioned within the cells defined by the individual ones of the base transceiver stations coupled to the base station controller.

The base station controller is coupled, in turn, by way of a mobile switching center/gateway mobile switching center (MSC/GMSC) 24 to the packet data network 18 and the public switched telephonic network 19. Correspondent nodes are coupled to the respective networks 18 and 19. Here, a correspondent node (CN) 28 is representative of any of such nodes. Here, the correspondent node 28 is coupled to both the networks 18 and 19 and is representative of a node coupled to either of such networks.

Communication paths are formable through various parts of the network part of the communication system and upon the radio link 14 to permit the communication of data between the correspondent node and the mobile station. For instance, when the correspondent node forms a telephonic station, the correspondent node forms a calling station at which a call is originated as well as a called station to which a call is terminated. When forming a telephonic station, the correspondent node is identified by a numeric identifier, i.e., a “telephone number” and the numeric identifier is used pursuant to call signaling that is carried out pursuant to call set-up procedures. During a call set-up procedure, the numeric identifier of the called station is entered at the calling station, and both the numeric identifiers of the calling station and the called station are used pursuant to the call set-up procedures.

When, for instance, a user of the mobile station uses the mobile station from which to originate a call to the correspondent node 28, the numeric identifier associated with the correspondent node is entered at the mobile station. Conversely, when a call is to be terminated at the mobile station, the numeric identifier that identifies the mobile station is entered at the correspondent node and communicated pursuant to call set-up procedures.

When the correspondent node is representative of a text message source or destination, the textual, or other, data is entered at, or delivered to, the correspondent node. When the mobile station is to be the destination of the text message entered at the correspondent node, the textual data is communicated to the mobile station. And, when the textual data is originated at the mobile station, the data is entered thereat for communication to the correspondent node.

The mobile station is here shown to include radio transceiver circuitry formed of a transmit part 42 and a receive part 44. When data is to be communicated by the mobile station, the transmit part is utilized to convert the data into a form to permit its communication by way of the radio channels defined upon the radio link 14 to the network part of the communication system. And, when data is communicated to the mobile station, the receive part 44 detects and operates upon such data.

The mobile station further includes user interface apparatus 48 of an embodiment of the present invention. The user interface apparatus is here shown to include a user actuator 52, a user display 54, and a user display screen manager 56. The elements shown in the figure are functionally represented and are implemented in any desired manner.

In the exemplary implementation, the user actuator 52 comprises a telephonic keypad actuable by a user to enter input commands, such as the telephonic identifiers identifying a called party and textual information used to form a textual, or other message. The user display 54, in the exemplary implementation, comprises a liquid crystal display (LCD) that is divisible into a first part 58 and a second part 62. And, the manager 56 is, in the exemplary implementation, formed of processing circuitry at which algorithms are executable to manage the display of display indicia upon the portions 58 and 62 of the user display.

The manager 56 is coupled, here represented by way of the line 64, to receive indications of input actuations entered by way of the user actuator 52. And, the manager is coupled, here by way of the line 66, to receive indications of data received by the receive part 44.

The manager operates to cause display of display indicia characters, such as text characters or icon characters on the user display in a manner to facilitate their perception by a visually-impaired user. The manager causes a sequence, or at least a portion of a sequence, to be displayed at the first part 58 of the user display. And, the manager causes one or more characters of the sequence displayed at the first part 58 to be displayed in enlarged form at the second part 62. Because of the enlargement of the character, a visually impaired user is better able to perceive the character. And, the manager further causes the location of the character in the sequence displayed at the first part 58 in enlarged form at the second part 62 to be indicated in some manner at the first display part. The user's perception of the character in the context of the sequence of characters which the character is associated is thereby also provided, further facilitating the user's perception of the character and its context.

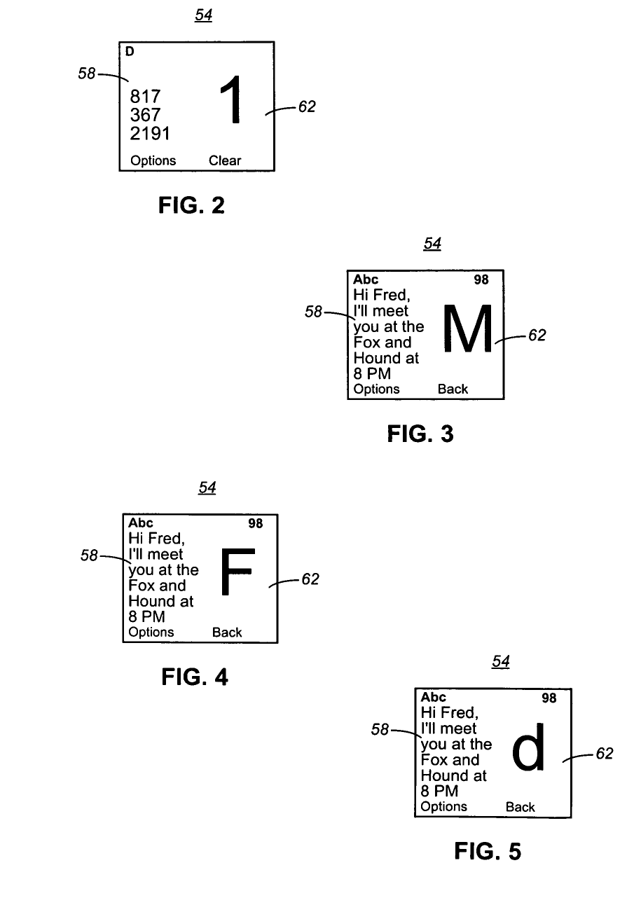

FIG. 2 illustrates an exemplary display caused to be displayed upon the user display 54 by the manager 56. Here, the most recently entered number, i.e., “1” is displayed individually at the second part 62 in a maximal font size supported by the vertical height of the user display as well as, concurrently, also as the ending digit of the phone number displayed at the first part 58. The digit is displayed in the first part in bold face in the text string to permit a user unable distinctly to view the character in the smaller font at which it appears at the first part 58 to determine its relative position within the string. Alternately, when the user display forms a color display, displaying the digit “1” in a color different from that of the other digits is alternately provided.

FIG. 3 illustrates an exemplary display caused to be displayed by the manager 56 upon the user display 54. Here, a sequence of characters forming a text message is displayed at the first part 58, and a most-recently entered character of which is concurrently displayed at the second part 62.

FIG. 4 illustrates the same text message displayed at the first part 58, but with another character, here “F” is displayed at the second part 62 in an enlarged font size.

FIG. 5 also illustrates the user display 54, here again with the same text message displayed at the first part 58 of the user display. Here, the character “d” is displayed at the second part 62. The color at which the character “d” is displayed in the first part 58 differs with the color at which the other characters of the text message are displayed, thereby to facilitate the user's perception of the context of the character in the text sequence. Here, the character displayed in the second part 62 is of the same color as that which is used to identify the character in the first part 58.

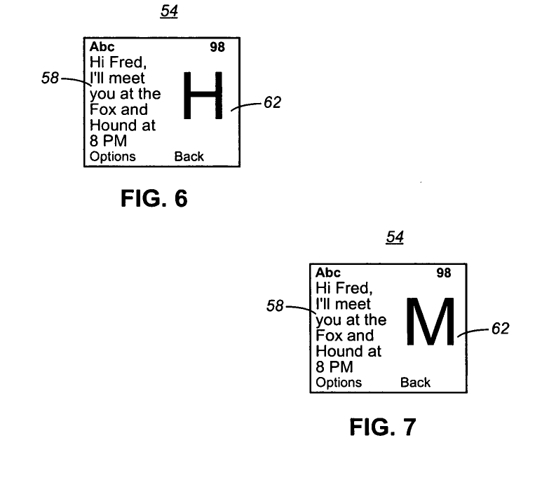

FIG. 6 again illustrates the same text message displayed at the first part 58 of the user display. Here, the character “H” displayed at the second part 62 is of the same color as the corresponding character displayed at the first part 58. the character “H” is the first character of the text string and is of a color unique to its position. Here, e.g., the first character in the text string is red.

FIG. 7 also again illustrates the same text message displayed at the first part 58. Here, the character “M”, forming part of the text message, is displayed in enlarged font size at the second part 62. Again, the enlarged character and the corresponding character forming part of the text message are displayed in a common color. Here, the character “M” is the final character in the text string and is of a color unique to its position. Here, e.g., the final character in the text string is blue. Displaying the character in enlarged font improves the likelihood that the character shall be able to be perceived well by a user of diminished visual acuity, and the indication of its corresponding position in the sequence of characters improves the likelihood that the context of the character shall be better understood.

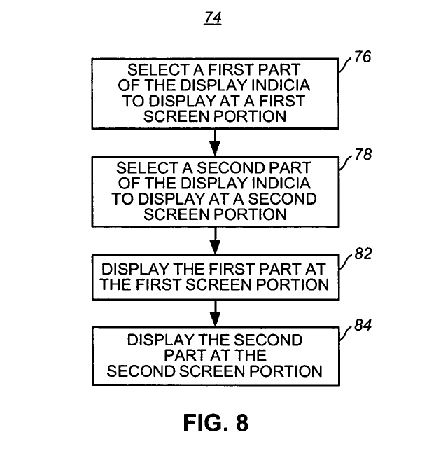

FIG. 8 illustrates a method flow diagram, shown generally at 74, representative of the method steps of the method of operation of an embodiment of the present invention. The method 74 facilitates viewing of display indicia at a user interface of a portable communication device.

First, and as indicated by the block 76, a first part of the display indicia is selected to be displayed at a first screen portion of a display screen. Then, and as indicated by the block 78, a second part of the display indicia is selected to be displayed at a second screen portion of the display screen. The second part and the first part have an overlapping display indicia element.

Then, and as indicated by the block 82, the first part of the display indicia is displayed at the first screen portion of the display screen. When displayed thereat, the first part of the display indicia is of a first size. And, as indicated by the block 84, the second part of the display indicia is displayed at the second screen portion of the display screen. When displayed thereat, the second part of the display indicia is of a second size.

Thereby, through operation of an embodiment of the present invention, a manner is provided by which to facilitate viewing of display indicia characters by a user of impaired visual acuity. One or more characters is caused to be displayed in an enlarged size. Concurrent with such display in the enlarged size, a sequence of display indicia characters is displayed in which the character that is also displayed in enlarged size is indicated to indicate its context in the sequence of characters.

The previous descriptions are of preferred examples for implementing the invention, and the scope of the invention should not necessarily be limited by this description. The scope of the present invention is defined by the following claims.

1. In a portable communication device operable in a communication system, an improvement of a user interface apparatus for facilitating viewing display indicia thereat by a visually-impaired user said user interface apparatus comprising:
a display screen having a first screen portion and at least a second screen portion, the first screen portion for selectably displaying a first selected portion of the display indicia at a first display-indicia size and the second screen portion for selectably displaying a second selected portion of the display indicia at a second display-indicia size, the first and second selected portions, respectively, having an overlapping display indicia element; and
a user display screen manager adapted to receive indiciations of the display indicia to be visually displayed, said user display screen manager for selecting which part of the display indicia to comprise the first selected portion displayed at the first screen portion of said display screen and which part of the display indicia to comprise the second selected portion displayed at the second screen portion and to manage display of the first and second selected portions, respectively, at respective ones of the first and second screen portions of said screen display.

2. The apparatus of claim 1 wherein the display indicia of which the first selected portion thereof and the second selected portion thereof are selectably displayed on said display screen comprises text data.

3. The apparatus of claim 2 wherein the first selected portion of the display indicia, when displayed at the first screen portion of said display screen is displayed at a first font size and wherein the second selected portion of the display indicia, when displayed at the second screen portion of said display screen, is displayed at a second font size.

4. The apparatus of claim 3 wherein the first font size is smaller than the second font size.

5. The apparatus of claim 3 wherein the overlapping display indicia comprises at least one textual character of the text data, the at least one textual character displayed at the first font size at the first screen portion of said display screen and the at least one textual character displayed at the second font size at the second screen portion of said display screen.

6. The apparatus of claim 5 wherein said user display screen manager selects display of the at least one textual character at the first screen portion concurrent with display of the at least one textual character at the second screen portion.

7. The apparatus of claim 6 wherein the text data comprises a sequence of textual characters wherein the at least one textual character comprises a subset of the sequence of textual characters and wherein said user display screen manager selects display of the subset formed of the at least one textual character at the second screen portion and selects display of the subset formed of the at least one textual character together with the at least one additional textual character at the first screen portion of said screen display.

8. The apparatus of claim 1 wherein the display indicia of which the first selected portion thereof and the second selected portion thereof are selectably displayed on said display screen comprises non-textual icons.

9. The apparatus of claim 8 wherein the first selected portion of the display indicia, when displayed at the first screen portion of said display screen portion of said display screen id displayed at a first icon-size and wherein the second selected portion of the display indicia, when displayed at the second screen portion of said display screen, is displayed at a second icon-size.

10. The apparatus of claim 9 wherein the first icon-size is smaller than the second icon-size.

11. The apparatus of claim 8 wherein the overlapping display indicia comprises at least one non-textual icon of the non-textual icons, the at least one non-textual icon displayed at the first icon-size at the first screen portion of said display screen and the at least one non-textual icon displayed at the second icon-size at the second screen portion of said display screen.

12. The apparatus of claim 1 wherein said user display screen manager successively reselects at successive selection intervals which part of the display indicia to comprise the first selected portion and which part of the display indicia to comprise the second selected portion.

13. The apparatus of claim 1 wherein the display indicia comprises a sequence of display indicia, and wherein selections made by said user display screen manager at the successive selection intervals to be displayed at the first screen portion are of successively-adjacent display characters, thereby to create a scrolling effect.

14. The apparatus of claim 1 wherein the user interface further comprises a user actuator actuable by a user, and wherein the successive selection intervals are defined by selected user actuation of the user actuator.

15. The apparatus of claim 1 wherein said display screen comprises a color screen and wherein the overlapping display indicia element is displayed in a common color at both the first screen portion and at the second screen portion of said display screen.

16. The apparatus of claim 1 wherein the overlapping display indicia element of the first selected portion displayed on the first screen portion is identified as overlapping display indicia that also forms at least part of the second selected portion displayed on the second screen portion of said screen display.

17. A method for facilitating viewing of display indicia at a user interface of a portable communication device, said method comprising:
selecting a first part of the display indicia to be displayed at a first screen portion of a display screen;
selecting a second part of the display indicia to be displayed at a second screen portion of the display screen, the second part and the first part having an overlapping display indicia element;
displaying the first part of the display indicia at the first screen portion of the display screen, such that when displayed thereat, the first part of the display indicia is of a first size; and
displaying the second part of the display indicia at the second screen portion of the display screen, such that, when displayed thereat, the second part of the display indicia is of a second size.

18. The method of claim 17 wherein the second size at which the second part of the display indicia is displayed is larger than the first size at which the first part of the display indicia is displayed.

19. The method of claim 17 comprising the further operation of indicating, in human perceptible form, the overlapping display indicia element of the first part of the display indicia during display of the first selected part during said operation of displaying the first part.

20. The method of claim 17 wherein said operation of displaying the first part and displaying the second part are performed concurrently.
